(19) United States
(12) Patent Application Publication
(10) Pub. No.: US 2025/0093511 A1
(43) Pub. Date: Mar. 20, 2025

(54) Apparatus for Controlling Vehicle and Method Thereof

(71) Applicants: Hyundai Motor Company, Seoul (KR); Kia Corporation, Seoul (KR)

(72) Inventor: Won Je Jang, Namyangju-Si (KR)

(21) Appl. No.: 18/648,779

(22) Filed: Apr. 29, 2024

(30) Foreign Application Priority Data
Sep. 20, 2023 (KR) 10-2023-0125737

(51) Int. Cl. G01S 17/58; B60W 60/00; G01S 7/48; G01S 17/88

(52) U.S. Cl. CPC G01S 17/58; B60W 60/0015; G01S 7/4808; G01S 17/88; B60W 2420/408; B60W 2554/80; B60W 2556/20

(57) ABSTRACT

A vehicle control apparatus may include a light detection and ranging (LiDAR), and a processor. The processor may identify a first speed of an external vehicle based on identifying a first virtual box corresponding to the external. The processor may determine a confidence level of the first speed, and may determine whether the first speed is stable. When the first speed is determined to be unstable, the processor may assign, to a second virtual box, one of a plurality of speeds.

### CROSS-REFERENCE TO RELATED APPLICATION

This application claims the benefit of priority to Korean Patent Application No. 10-2023-0125737, filed in the Korean Intellectual Property Office on Sep. 20, 2023, the entire contents of which are incorporated herein by reference.

### TECHNICAL FIELD

The present disclosure relates to an apparatus for controlling a vehicle control apparatus and a method thereof, and more specifically, relates to a technology for identifying an external object by using one or more sensors, such as light detection and ranging (LiDAR) devices.

### BACKGROUND

An external object may be identified by using various sensors to assist a vehicle in driving.

In particular, while the vehicle is driving in a driving assistance device activation mode or an autonomous driving mode, the external object may be identified by using a sensor, such as a LiDAR device.

The speed of an external vehicle may not be accurately measured through the LiDAR. While the vehicle is driving in the driving assistance device activation mode or the autonomous driving mode, the driving safety and driving experience may be improved if the speed of the external vehicle can be more accurately measured.

### SUMMARY

The following summary presents a simplified summary of certain features. The summary is not an extensive overview and is not intended to identify key or critical elements.

An aspect of the present disclosure provides a vehicle control apparatus that identifies a speed to be assigned to a virtual box by using at least one of a speed of an external vehicle, or a displacement of the virtual box corresponding to the external vehicle, or any combination thereof, and a method thereof.

An aspect of the present disclosure provides a vehicle control apparatus that determines a virtual box having an unstable speed and assigns a stable speed to the virtual box having the unstable speed, and a method thereof.

An aspect of the present disclosure provides a vehicle control apparatus that reduces a speed error caused by a shape error of an object, and a method thereof.

The technical problems to be solved by the present disclosure are not limited to the aforementioned problems, and any other technical problems not mentioned herein will be clearly understood from the following description by those skilled in the art to which the present disclosure pertains.

An apparatus of a first vehicle may comprise: at least r is one sensor; and a processor, wherein the processor configured to: determine, based on the at least one sensor, a first virtual box corresponding to an external vehicle and associated with a first time point; identify, based on the first virtual box, a first speed of the external vehicle at the first time point; determine whether a confidence level of the first speed exceeds a reference confidence level, based on at least one of information of the first virtual box, information of a second virtual box identified at a second time point after the first time point, or driving information of the first vehicle, or any combination thereof; determine whether the first speed is stable, based on a first displacement obtained by a difference between a first location of the first virtual box and a second location of the second virtual box, a predicted displacement of the first virtual box predicted by the first speed of the external vehicle at the first time point, and a predetermined threshold displacement, after the confidence level of the first speed exceeds the reference confidence level; select a second displacement, which has the smallest difference from the predicted displacement, from among displacements based on a difference between first representative points included in the first virtual box, and second representative points, which respectively correspond to the first representative points and which are included in the second virtual box, after the first speed is determined to be unstable; and assign, to the second virtual box, one of a second speed based on the selected second displacement, a third speed based on the second displacement and a third displacement obtained by applying an algorithm to first points included in the first virtual box and second points included in the second virtual box, or a fourth speed based on the second displacement and the predicted displacement.

The processor may be configured to: identify the confidence level of the first speed based on at least one of a difference between a first size of the first virtual box and a second size of the second virtual box, a difference between a first heading direction of the first virtual box and a second heading direction of the second virtual box, a difference between a first yaw rate of the first vehicle identified at the first time point and a second yaw rate of the first vehicle identified at the second time point, a difference between a first width of the first virtual box and a second width of the second virtual box, whether the first location and the second location are located in a boundary region of the at least one sensor, or whether the first virtual box or the second virtual box is obstructed, or any combination thereof. The boundary region of the at least one sensor may comprise a region within a designated distance from a boundary line of a field of view (FOV) of the at least one sensor.

The processor may be configured to: increase the confidence level of the first speed based on the difference between the first size of the first virtual box and the second size of the second virtual box being smaller than or equal to a reference rate, the difference between the first heading direction of the first virtual box and the second heading direction of the second virtual box being smaller than or equal to a reference angle, the difference between the first width of the first virtual box and the second width of the second virtual box being smaller than or equal to a reference width, the first virtual box and the second virtual box being not located in the boundary region of the at least one sensor, a component of a first axis direction included in the first heading direction of first virtual box and the second heading direction of the second virtual box being greater than a component of a second axis direction, the first virtual box and the second virtual box being not obstructed, or the difference between the first yaw rate of the first vehicle identified at the first time point and the second yaw rate of the first vehicle identified at the second time point being smaller than or equal to a reference yaw rate.

The processor may be configured to: initialize the confidence level of the first speed based on the difference between the first size of the first virtual box and the second size of the second virtual box exceeding a reference rate, the difference between the first heading direction of the first virtual box and the second heading direction of the second virtual box exceeding a reference angle, the difference between the first width of the first virtual box and the second width of the second virtual box exceeding a reference width, the difference between a speed of the first vehicle at the first time point and the speed of the first vehicle at the second time point exceeding a reference speed, or the difference between the first yaw rate of the first vehicle identified at the first time point and the second yaw rate of the first vehicle identified at the second time point exceeding a reference yaw rate.

The processor may be configured to: determine that the first speed is unstable, based on a difference between the first displacement and the predicted displacement exceeding the threshold displacement; and determine that the first speed is stable, based on the difference between the first displacement and the predicted displacement being smaller than or equal to the threshold displacement.

The processor may be configured to: assign the first speed to the second virtual box based on the confidence level of the first speed being smaller than or equal to a first reference confidence level; determine that the first speed is unstable, based on the difference between the first displacement and the predicted displacement exceeding a first threshold displacement when the confidence level of the first speed exceeds the first reference confidence level and is smaller than or equal to a second reference confidence level exceeding the first reference confidence level; determine that the first speed is unstable, based on the difference between the first displacement and the predicted displacement exceeding a second threshold displacement smaller than the first threshold displacement when the confidence level of the first speed exceeds the second reference confidence level; and determine that the first speed is unstable, based on the difference between the first displacement and the predicted displacement exceeding a third threshold displacement exceeding the first threshold displacement when the first virtual box or the second virtual box is identified in a boundary region of the at least one sensor. The boundary region of the at least one sensor may comprise a region within a designated distance from a boundary line of a field of view (FOV) of the at least one sensor.

The processor may be configured to: identify, as at least one of the first representative points and the second representative points, at least one of vertices of the first virtual box and the second virtual box, a minimum value of a first axis, a maximum value of the first axis, a minimum value of a second axis, or a maximum value of the second axis, or any combination thereof and points included in the first virtual box and the second virtual box on a plane, which is formed by the first axis and the second axis among the first axis, the second axis, and a third axis.

The processor may be configured to: obtain at least one of the first representative points or at least of the second representative points based on a direction, in which the first virtual box is located relative to the first vehicle, based on the first virtual box or the second virtual box being identified in a boundary region of the at least one sensor. The boundary region of the at least one sensor may comprise a region within a designated distance from a boundary line of a field of view (FOV) of the at least one sensor.

The processor may be configured to: assign the second speed to the second virtual box, based on the first virtual box and the second virtual box being identified as exceeding a designated distance from the first vehicle not to apply the algorithm to the first points and the second points.

The processor may be configured to: obtain the third displacement based on applying the algorithm to the first points and the second points, based on the first virtual box and the second virtual box being identified at a designated distance or less from the first vehicle to apply the algorithm to the first points and the second points; and assign the third speed, which is based on an average of the third displacement and the second displacement, to the second virtual box.

The processor may be configured to: obtain a fourth displacement by applying a weight to each of the second displacement and the predicted displacement based on a difference between the second displacement and the predicted displacement being greater than or equal to a threshold value; and assign the fourth speed to the second virtual box based on obtaining the fourth speed by using the fourth displacement.

These and other features and advantages are described in greater detail below.

### BRIEF DESCRIPTION OF THE DRAWINGS

The above and other objects, features and advantages of the present disclosure will be more apparent from the following detailed description taken in conjunction with the accompanying drawings:

FIG. 1 shows an example of a block diagram of a vehicle control apparatus;

FIG. 2 shows an example related to a displacement of a virtual box;

FIG. 3 shows an example of identifying representative points of a virtual box;

FIG. 4 shows an example in which a virtual box is identified in a boundary region of a LiDAR;

FIG. 5 shows an example of obtaining a displacement based on first representative points of a virtual box identified at a first time point and second representative points of a virtual box identified at a second time point;

FIG. 6 shows an example of an example result, to which one or more aspects of the present disclosure is applied, and a comparative example of a result to which the one or more aspects of the present disclosure is not applied;

FIG. 7 shows an example of a flowchart related to a vehicle control method;

FIG. 8 shows an example of a flowchart related to a vehicle control method; and

FIG. 9 illustrates an example of a computing system related to a vehicle control apparatus or vehicle control method.

### DETAILED DESCRIPTION

Hereinafter, various examples of the present disclosure will be described in detail with reference to the accompanying drawings. In adding reference numerals to components of each drawing, it should be noted that the same components have the same reference numerals, although they are indicated on another drawing. Furthermore, in describing the features of the present disclosure, detailed descriptions associated with well-known functions or configurations will be omitted when they may make subject matters of the present disclosure unnecessarily obscure. In describing elements of the present disclosure, the terms first, second, A, B, (a), (b), and the like may be used herein. These terms are only used to distinguish one element from another element, but do not limit the corresponding elements irrespective of the nature, order, or priority of the corresponding elements. Furthermore, unless otherwise defined, all terms including technical and scientific terms used herein are to be interpreted as is customary in the art to which the present disclosure belongs. It will be understood that terms used herein should be interpreted as having a meaning that is consistent with their meaning in the context of the present disclosure and the relevant art and will not be interpreted in an idealized or overly formal sense unless expressly so defined herein.

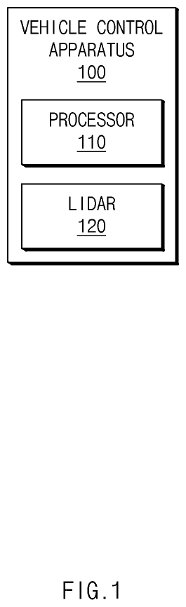

Hereinafter, various examples of the present disclosure will be described in detail with reference to FIGS. 1 to 9.

FIG. 1 shows an example of a block diagram of a vehicle control apparatus.

Referring to FIG. 1, a vehicle control apparatus 100 may be implemented inside or outside a vehicle, and some of components included in the vehicle control apparatus 100 may be implemented inside or outside the vehicle. In some implementations, the vehicle control apparatus 100 may be integrated with internal control units of a vehicle and may be implemented with a separate device so as to be connected to control units of the vehicle by using a separate connector and/or a connection interface. For example, the vehicle control apparatus 100 may further include components not shown in FIG. 1.

Referring to FIG. 1, the vehicle control apparatus 100 may include a processor 110 and one or more sensors (e.g., a LiDAR 120 and/or any other object detection sensors, which may emit a signal and receive the signal reflected from an object). The processor 110 or the LiDAR 120 may be electrically and/or operably coupled with each other by an electronic component including a communication bus.

Hereinafter, pieces of hardware coupled operably may include hardware components coupled via a direct and/or indirect connection between the pieces of hardware and may be implemented by and/or wirelessly such that second hardware is controlled by first hardware among the pieces of hardware.

Although different blocks are shown, aspects are not limited thereto. Some of the pieces of hardware in FIG. 1 may be included in a single integrated circuit including a system on a chip (SoC). The type or number of hardware included in the vehicle control apparatus 100 is not limited to that shown in FIG. 1. For example, the vehicle control apparatus 100 may include only some of the pieces of hardware shown in FIG. 1.

The vehicle control apparatus 100 may include hardware for processing data based on one or more instructions. The hardware for processing data may include the processor 110. For example, the hardware for processing data may include an arithmetic and logic unit (ALU), a floating point unit (FPU), a field programmable gate array (FPGA), a central processing unit (CPU), and/or an application processor (AP). The processor 110 may have a structure of a single-core processor, or may have a structure of a multi-core processor including a dual core, a quad core, a hexa core, or an octa core, etc.

The LiDAR 120 of the vehicle control apparatus 100 may obtain data sets from identifying objects located in proximity to the vehicle control apparatus 100. For example, the LiDAR 120 may identify at least one of a location of the object, a movement direction of the object, or a speed of the object, or any combination thereof, for example, based on a pulse laser signal emitted from the LiDAR 120 being reflected by the object and returned.

For example, the LiDAR 120 may obtain data sets including a plurality of points, of object(s), in the space defined by a first axis, a second axis, and a third axis, for example, based on a pulse laser signal reflected from the object(s). For example, the LiDAR 120 may obtain data sets including a plurality of points in the space, which is formed by the first axis, the second axis, and the third axis, based on receiving the pulse laser signal at a designated period. For example, the first axis may include an x-axis (e.g., the driving direction of the vehicle, the longitudinal axis of the vehicle, or the direction from the rear center of the vehicle to the front center of the vehicle). For example, the second axis may include a y-axis (e.g., the horizontal axis of the vehicle, the transverse axis of the vehicle). For example, the third axis may include a z-axis (e.g., the vertical axis of the vehicle). However, the first axis, the second axis, and/or the third axis are not limited to the above examples.

The processor 110 included in the vehicle control apparatus 100 may emit light from a vehicle by using the LiDAR 120. For example, the processor 110 may receive light emitted from the vehicle through the LiDAR 120. For example, the processor 110 may identify at least one of a location, a speed, or a moving direction, or any combination thereof of an object, for example, based on a time required to transmit light emitted from the vehicle and a time required to receive light emitted from the vehicle. A LiDAR device may measure the time it takes for emitted light to travel to an object and back. The LiDAR device may record the time from when the laser pulse left the LiDAR device to when it is returned to calculate the distance between the LiDAR device and the object.

For example, the processor 110 may obtain data sets including a plurality of points based on the time required to transmit light emitted from the vehicle and the time required to receive light emitted from the vehicle. The processor 110 may obtain data sets for expressing a plurality of points in a three-dimensional virtual coordinate system including the first axis, the second axis, and the third axis.

The processor 110 may identify a first virtual box corresponding to an external vehicle through the LiDAR 120. For example, the processor 110 may identify the first virtual box based on a first data set obtained at a first time point. For example, the processor 110 may identify the first virtual box based on a plurality of points, which are obtained at the first time point and which are included in the first data set.

In an example, the processor 110 may identify, through the LiDAR 120, a first speed of the external vehicle at the first time point based on the first virtual box corresponding to the external vehicle.

In an example, the processor 110 may identify at least one of information of the first virtual box, or driving information of the vehicle including the vehicle control apparatus 100, or any combination thereof. The processor 110 may determine whether a confidence level of the first speed exceeds a reference confidence level, based on at least one of the information of the first virtual box, or the driving information of the vehicle, or any combination thereof.

For example, the information of the first virtual box may include at least one of a size of the first virtual box, a first heading direction of the first virtual box, a shape of the first virtual box, whether the first virtual box is located in a boundary region of the LiDAR 120, or whether the first virtual box is occluded, or any combination thereof. For example, the boundary region of the LiDAR 120 may include a region within a designated distance from the boundary line of the field of view (FOV) of the LiDAR 120.

For example, the driving information of the vehicle may include at least one of a yaw rate of the vehicle, whether the vehicle is driving in a ramp section, whether the vehicle is rotating, or a speed change rate of the vehicle, or any combination thereof.

For example, the processor may identify the confidence level of the first speed based on Table 1 below.

TABLE 1

| Increase in | |
|---|---|
| confidence | |
| level | Condition |
| +n | 1) When difference between size of first virtual |
| | box and size of second virtual box is smaller than |
| | or equal to reference rate |
| | 2) When difference between first heading |
| | direction of first virtual box and second heading |
| | direction of second virtual box is smaller than or |
| | equal to reference angle |
| | 3) When difference between first width of first |
| | virtual box and second width of second virtual box |
| | is smaller than or equal to reference width |
| | 4) When first virtual box and second virtual box |
| | are not located in boundary region of LiDAR 120 |
| | 5) When component of first axis direction is |
| | greater than component of second axis direction |
| | included in first heading direction of first |
| | virtual box and second heading direction of second |
| | virtual box |
| | 6) When first virtual box and second virtual box |
| | are not occluded, or |
| | 7) When difference between first yaw rate of |
| | vehicle identified at first time point and second |
| | yaw rate of vehicle identified at second time |
| | point is smaller than or equal to reference yaw rate |
| +n/2 | 1) When first virtual box or second virtual box |
| | is occluded |
| | 2) When difference between first yaw rate and |
| | second yaw rate exceeds reference yaw rate, but |
| | difference between speed of vehicle identified at |
| | first time point and speed of vehicle identified |
| | at second time point is smaller than or equal to |
| | reference speed |
| Reset | 1) When confidence level exceeds ‘m’, changing |
| | confidence level to ‘k’ based on satisfying |
| | conditions included in 2) below |
| | 2) When confidence level exceeds ‘k’ and is |
| | smaller than ‘m’ |
| | a. When difference between first width of |
| | first virtual box and second width of second |
| | virtual box exceeds reference width |
| | b. When first virtual box or second virtual |
| | box is identified in boundary region of LiDAR 120 |
| | c. When component of second axis direction |
| | included in first heading direction of first |
| | virtual box and second heading direction of second |
| | virtual box is greater than component of first |
| | axis direction |
| | d. When difference between first location of |
| | first virtual box and second location of second |
| | virtual box exceeds reference distance |
| | e. When difference between speed of vehicle at |
| | first time point and speed of vehicle at second |
| | time point exceeds threshold value |

In an example, the processor 110 may increase the confidence level of the first speed by ‘n’ based on the fact that a difference between the size of the first virtual box and the size of the second virtual box is smaller than or equal to a reference rate, a difference between the first heading direction of the first virtual box and a second heading direction of the second virtual box is smaller than or equal to a reference angle, a difference between the first width of the first virtual box and the second width of the second virtual box is smaller than or equal to a reference width, the first virtual box and the second virtual box are not located in a boundary region of the LiDAR 120, a component of the first axis direction is greater than a component of the second axis direction included in the first heading direction of the first virtual box and the second heading direction of the second virtual box, the first virtual box and the second virtual box are not occluded, or a difference between a first yaw rate of the vehicle identified at the first time point and a second yaw rate of the vehicle identified at the second time point is smaller than or equal to a reference yaw rate.

In an example, the processor 110 may increase the confidence level of first speed by ‘n/2’ based on the fact that the first virtual box or the second virtual box is occluded, or a difference between the first yaw rate and the second yaw rate exceeds a reference yaw rate, but a difference between the speed of the vehicle identified at the first time point and the speed of the vehicle identified at the second time point is smaller than or equal to a reference speed.

In an example, the processor 110 may initialize the confidence level of the first speed or may change the confidence level of the first speed to a designated value, based on the fact that a difference between a first width of the first virtual box and a second width of the second virtual box exceeds a reference width, the first virtual box or the second virtual box is identified in a boundary region of the LiDAR 120, a component of the second axis direction included in the first heading direction of the first virtual box and the second heading direction of the second virtual box is greater than a component of the first axis direction, a difference between a first location of the first virtual box and a second location of the second virtual box exceeds a reference distance, or a difference between the speed of the vehicle at the first time point and the speed of the vehicle at the second time point exceeds a threshold value.

In an example, the processor 110 may identify that the confidence level of the first speed exceeds the reference confidence level. The processor 110 may identify a first location of the first virtual box at the first time point. The processor 110 may identify a second location of the second virtual box at the second time point. When the confidence level of the first speed exceeds the reference confidence level, the processor 110 may identify a difference between the first location of the first virtual box and the second location of the second virtual box. The processor 110 may obtain a first displacement by the difference between the first location and the second location.

In an example, the processor 110 may identify a predicted displacement of the first virtual box by the first speed of the external vehicle at the first time point. For example, the processor 110 may obtain the predicted displacement of the first virtual box by using the first speed and a difference between a timing, at which the first virtual box is obtained, and a timing at which the second virtual box is obtained.

In an example, the processor 110 may determine whether the first speed is stable, based on the first displacement, the predicted displacement and a predetermined threshold displacement. For example, the threshold displacement may be set to a value that is different depending on the confidence level of the first speed.

In an example, when the confidence level of the first speed is smaller than or equal to the reference confidence level, the processor 110 may assign the first speed to the second virtual box.

In an example, when the confidence level of the first speed exceeds the reference confidence level, the processor 110 may obtain the first displacement based on the difference between the first location of the first virtual box and the second location of the second virtual box.

In an example, the processor 110 may predict the predicted displacement of the first virtual box based on the first speed of the external vehicle at the first time point. For example, the processor 110 may predict the predicted displacement of the first virtual box based on applying the first speed of the external vehicle at the first time point to the first virtual box.

In an example, when the confidence level of the first speed exceeds the reference confidence level, the processor 110 may determine whether the first speed is stable, based on the first displacement obtained by a difference between the first location of the first virtual box and the second location of the second virtual box, the predicted displacement of the first virtual box predicted by the first speed of the external vehicle at the first time point, and a predetermined threshold displacement.

For example, when the confidence level of the first speed exceeds the first reference confidence level and is smaller than or equal to a second reference confidence level exceeding the first reference confidence level, the processor 110 may determine that the first speed is unstable, based on a difference between the first displacement and the predicted displacement exceeding a first threshold displacement.

For example, when the confidence level of the first speed exceeds the second reference confidence level, the processor 110 may determine that the first speed is unstable, based on the difference between the first displacement and the predicted displacement exceeding a second threshold displacement smaller than the first threshold displacement.

For example, when the first virtual box is identified in a boundary region of a LiDAR, the processor 110 may determine that the first speed is unstable, based on the difference between the first displacement and the predicted displacement exceeding a third threshold displacement exceeding the first threshold displacement.

For example, the first reference confidence level may include approximately 5. For example, the second reference confidence level may include approximately 20. For example, the first threshold displacement may include approximately 0.1 m. For example, the second threshold displacement may include approximately 0.05 m. For example, the third threshold displacement may include approximately 0.2 m.

In an example, the processor 110 may identify first representative points included in the first virtual box. The identify second representative points processor 110 may included in the second virtual box.

For example, when the first speed is determined to be unstable, the processor 110 may identify displacements based on a difference between first representative points included in the first virtual box, and second representative points, which respectively correspond to the first representative points and which are included in the second virtual box.

For example, when the first speed is determined to be unstable, the processor 110 may select the second displacement, which has the smallest difference from the predicted displacement, from among the displacements based on the difference between the first representative points included in the first virtual box, and the second representative points, which respectively correspond to the first representative points and which are included in the second virtual box.

For example, the processor 110 may identify vertices of the first virtual box as at least one of the first representative points. For example, the processor 110 may identify at least one of a minimum value of the first axis, a maximum value of the first axis, a minimum value of the second axis, or a maximum value of the second axis, or any combination thereof among points included in the first virtual box on a plane formed by a first axis and a second axis among the first axis, the second axis, and the third axis. The processor 110 may identify, as at least one of the first representative points of the first virtual box, at least one of the minimum value of the first axis, the maximum value of the first axis, the minimum value of the second axis, or the maximum value of the second axis, or any combination thereof among the points included in the first virtual box on the plane formed by the first axis and the second axis among the first axis, the second axis, and the third axis.

For example, the processor 110 may identify vertices of the second virtual box as at least one of the second representative points. For example, the processor 110 may identify at least one of a minimum value of the first axis, a maximum value of the first axis, a minimum value of the second axis, or a maximum value of the second axis, or any combination thereof among points included in the second virtual box on the plane formed by the first axis and the second axis among the first axis, the second axis, and the third axis. The processor 110 may identify, as at least one of the second representative points of the second virtual box, at least one of the minimum value of the first axis, the maximum value of the first axis, the minimum value of the second axis, or the maximum value of the second axis, or any combination thereof among the points included in the second virtual box on the plane formed by the first axis and the second axis among the first axis, the second axis, and the third axis.

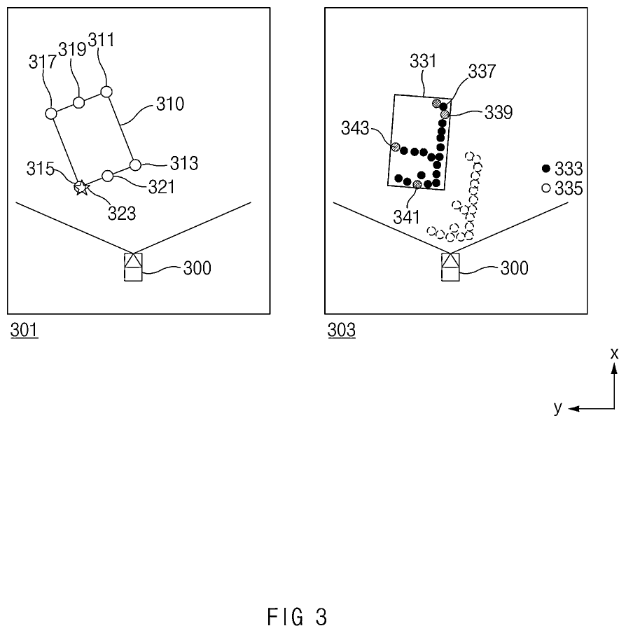

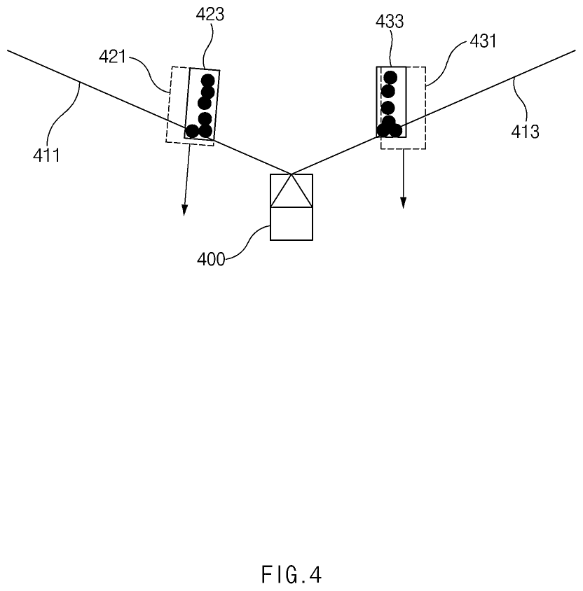

In an example, when the first virtual box or the second virtual box is identified in a boundary region of the LiDAR 120, the processor 110 may identify at least one of some of the first representative points, or some of the second representative points, or any combination thereof, based on a direction in which the first virtual box is located relative to the vehicle. Descriptions related to the first representative points and the second representative points will be described later in FIGS. 3 and 4.

In an example, the processor 110 may identify a second speed based on the selected second displacement. For example, the processor 110 may obtain the second speed based on dividing a second displacement by a time difference between the first time point and the second time point.

In an example, when the first virtual box and the second virtual box are identified beyond a designated distance (e.g., approximately 80 m) from the vehicle, the processor 110 may not apply an algorithm to first points and second points. For example, when the first virtual box and the second virtual box are identified beyond the designated distance from the vehicle not to apply the algorithm to the first points and the second points, the processor 110 may assign the second speed to the second virtual box.

In an example, the processor 110 may apply the algorithm to the first points included in the first virtual box and the second points included in the second virtual box. For example, the algorithm may include an iterative closest point (ICP) algorithm. For example, the ICP algorithm may include an algorithm for estimating a correspondence relationship between the first points and the second points. The processor 110 may obtain a third displacement by applying the algorithm to the first points included in the first virtual box and the second points included in the second virtual box. The processor 110 may obtain a third speed based on dividing the third displacement by the time difference between the first time point and the second time point.

In an example, when the first virtual box and the second virtual box are identified at a designated distance (e.g., approximately 80 m) or less from the vehicle, the processor 110 may apply the algorithm to the first points and the second points. When the first virtual box and the second virtual box are identified at a designated distance or less from the vehicle to apply the algorithm to the first points and the second points, the processor 110 may obtain the third displacement based on applying the algorithm to the first points and the second points. The processor 110 may identify the average of the third displacement and the second displacement. The processor 110 may obtain a third speed based on the average of the third displacement and the second displacement. For example, the processor may obtain the third speed based on dividing the average of the third displacement and the second displacement by the time difference between the first time point and the second time point. The processor 110 may assign the third speed, which is based on the average of the third displacement and the second displacement, to the second virtual box.

In an example, the processor 110 may obtain a fourth speed based on the second displacement and the predicted displacement. For example, the processor 110 may obtain a fourth displacement based on applying weights to the second displacement and the predicted displacement. For example, the processor 110 may obtain a fourth displacement, which is half of the sum of the second displacement to which the first weight is applied and the predicted displacement to which the second weight is applied, by applying a first weight to the second displacement and applying a second weight to the predicted displacement. The processor 110 may obtain the fourth speed by using the fourth displacement. For example, the processor 110 may obtain the fourth speed based on dividing the fourth displacement by the time difference between the first time point and the second time point. The processor 110 may assign the fourth speed to the second virtual box based on obtaining the fourth speed by using the fourth displacement.

As described above, when the first speed of the external vehicle identified at the first time point is not stable, the processor 110 of the vehicle control apparatus 100 may perform various operations to stabilize the speed of the second virtual box identified at the second time point. The processor 110 may assign, to the second virtual box, one of a second speed based on the selected second displacement, a third speed based on the second displacement and the third displacement, which is obtained by applying the algorithm to the first points included in the first virtual box and the second points included in the second virtual box, or a fourth speed based on the second displacement and the predicted displacement, thereby stabilizing a speed of the second virtual box identified at the second time point.

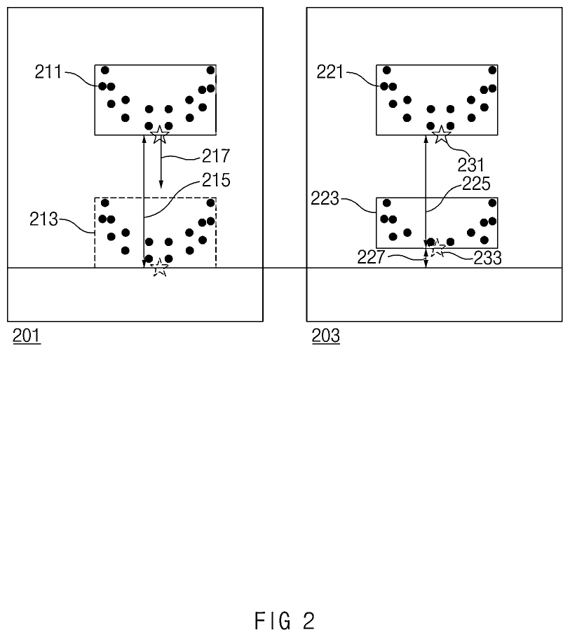

FIG. 2 shows an example related to a displacement of a virtual box.

Referring to FIG. 2, a processor (e.g., the processor 110 in FIG. 1) of a vehicle control apparatus (e.g., the vehicle control apparatus 100 of FIG. 1) may obtain at least one of a first displacement 225, or a predicted displacement 215, or any combination thereof based on virtual boxes 211 and 221 of a first time point.

Referring to a first example 201 in FIG. 2, the processor may identify a first virtual box 211 at the first time point. The processor may identify a first location of the first virtual box 211 at the first time point. The processor may obtain a first speed 217 of an external vehicle identified at the first time point.

For example, the processor may predict a second location of a second virtual box 213 at a second time point by applying the first speed 217 to the first virtual box 211 identified at the first time point. For example, the processor may identify the second location of the second virtual box 213 at the second time point by applying the first speed 217 to the first location of the first virtual box 211. The processor may obtain the predicted displacement of 215 based on a difference between the first location of the first virtual box 211 and the second location of the second virtual box 213.

Referring to a second example 203 in FIG. 2, the processor may identify a first virtual box 221 at the first time point. The processor may identify a second virtual box 223 based on a plurality of points obtained through a LiDAR (e.g., the LiDAR 120 in FIG. 1) at a second time point.

For example, the processor may identify a first reference point 231 of the first virtual box 221 identified at the first time point. For example, the processor may identify a second reference point 233 of the second virtual box 223 identified at the second time point. The processor may identify a distance between the first reference point 231 and the second reference point 233. The processor may obtain a first displacement 225 based on the distance between the first reference point 231 and the second reference point 233.

Referring to the first example 201 and the second example 203, the processor may identify a difference 227 between the predicted displacement 215 and the first displacement 225. The processor may obtain an absolute value of the difference 227 between the predicted displacement 215 and the first displacement 225. The processor may determine whether the first speed 217 is stable, based on whether the absolute value of the difference 227 between the predicted displacement 215 and the first displacement 225 exceeds a threshold displacement. For example, the threshold displacement described in FIG. 2 may include the first to third threshold displacements described in FIG. 1.

As described above, the processor of the vehicle control apparatus may determine whether the first speed is stable, based on whether the difference between the first displacement 225 and the predicted displacement 215 exceeds the threshold displacement, and may select a speed to be assigned to the second virtual box based on whether the first speed is stable, thereby improving a vehicle control system related to the vehicle control apparatus.

FIG. 3 shows an example of identifying representative points of a virtual box.

Referring to FIG. 3, a processor (e.g., the processor 110 in FIG. 1) of a vehicle control apparatus (e.g., the vehicle control apparatus 100 of FIG. 1) may identify representative points of virtual boxes 310 and 331. For example, the virtual boxes 310 and 331 may include at least one of a first virtual box identified at a first time point, or a second virtual box identified at a second time point, or any combination thereof.

Referring to a first example 301 in FIG. 3, the processor of the vehicle control apparatus may identify the virtual box 310 corresponding to an external vehicle located in front of a vehicle 300. The processor may identify representative points 311, 313, 315, 317, 319, and 321 included in the virtual box 310.

For example, the processor may identify a maximum value of a second axis direction from points included in a virtual box. The processor may identify a first vertex corresponding to the maximum value of the second axis direction as the representative point 311. For example, the processor may sequentially identify vertices (e.g., which are identified clockwise from the first vertex), based on identifying the first vertex corresponding to the maximum value of the second axis direction as the first representative point 311.

For example, the processor may identify a second vertex, which may be first identified in a clockwise direction of the first vertex, as the second representative point 313. The processor may identify a third vertex, which may be first identified in a clockwise direction of the second vertex, as the third representative point 315. The processor may identify a fourth vertex, which may be first identified in a clockwise direction of the third vertex, as the fourth representative point 317.

For example, if the virtual box 310 includes a line segment parallel to at least one of the first axis, or second axis, or any combination thereof, the processor may identify a top left vertex as the first representative point. The processor may sequentially identify vertices, which are identified clockwise from the top left vertex as representative points based on identifying the top left vertex as the first representative point.

The processor may identify the fifth representative point 319 between the first representative point 311 and the fourth representative point 317. The processor may identify the sixth representative point 321 between the second representative point 313 and the third representative point 315. For example, the processor may identify a midpoint between the first representative point 311 and the fourth representative point 317 as the fifth representative point 319. The processor may identify a midpoint between the second representative point 313 and the third representative point 315 as the sixth representative point 321.

For example, the processor may assign a first identifier to the first representative point 311. The processor may assign a second identifier to the second representative point 313. The processor may assign a third identifier to the third representative point 315. The processor may assign a fourth identifier to the fourth representative point 317. The processor may assign a fifth identifier to the fifth representative point 319. The processor may assign a sixth identifier to the sixth representative point 321.

For example, the first identifier may include an identifier indicating an upper side. For example, the second identifier may include an identifier indicating a right side. For example, the third identifier may include an identifier indicating a lower side. For example, the fourth identifier may include an identifier indicating a left side. For example, the fifth identifier may include an identifier indicating an upper center. For example, the sixth identifier may include an identifier indicating a lower center.

The processor may identify the reference point 323 of the virtual box 310. For example, the reference point 323 may include a reference point of at least one of a speed of an external vehicle corresponding to the virtual box 310, or a location of the virtual box 310, or any combination thereof.

Referring to the second example 303 in FIG. 3, the processor of the vehicle control apparatus may identify a virtual box 331 corresponding to an external vehicle identified in front of the vehicle 300.

For example, the processor may identify representative points 337, 339, 341, and 343 among a plurality of points 333 included in the virtual box 331. For example, the processor may identify the representative points 337, 339, 341, and 343 among the plurality of points 333 included in the virtual box 331 on a plane formed by a first axis and a second axis.

For example, the processor may identify coordinates of each of the plurality of points 333 included in the virtual box 331. The processor may identify the minimum value of the second axis from the plurality of points 333 included in the virtual box 331. The processor may identify the seventh representative point 343 including the minimum value of the second axis from the plurality of points 333 included in the virtual box 331.

For example, the processor may identify the maximum value of the second axis from the plurality of points 333 included in the virtual box 331. The processor may identify the eighth representative point 339 including the maximum value of the second axis from the plurality of points 333 included in the virtual box 331.

For example, the processor may identify the maximum value of the first axis from the plurality of points 333 included in the virtual box 331. The processor may identify the ninth representative point 337 including the maximum value of the first axis from the plurality of points 333 included in the virtual box 331.

For example, the processor may identify the minimum value of the first axis from the plurality of points 333 included in the virtual box 331. The processor may identify the tenth representative point 341 that includes the minimum value of the first axis from the plurality of points 333 included in the virtual box 331.

The virtual box 331 in the second example 303 may be generated based on the plurality of points 333 obtained at the second time point. A plurality of points 335 in the second example 303 may be obtained at the first time point.

The processor may apply an algorithm to the plurality of points 335 obtained at the first time point, and the plurality of points 333 obtained at the second time point. For example, the processor may apply the algorithm to a first point cloud including the plurality of points 335 obtained at the first time point, and a second point cloud including the plurality of points 333 obtained at the second time point. For example, the above-described algorithm may include an ICP algorithm.

The processor may obtain the third displacement described in FIG. 1 based on applying the algorithm to the plurality of points 335 obtained at the first time point and the plurality of points 333 obtained at the second time point, or the first point cloud including the plurality of points 335 obtained at the first time point and the second point cloud including the plurality of points 333 obtained at the second time point.

FIG. 4 shows an example in which a virtual box is identified in a boundary region of a LiDAR.

Referring to FIG. 4, a processor (e.g., the processor 110 in FIG. 1) of a vehicle control apparatus (e.g., the vehicle control apparatus 100 of FIG. 1) may identify virtual boxes 421, 423, 431, and 433 in boundary regions 411 and 413 of a LiDAR (e.g., the LiDAR 120 in FIG. 1).

The processor may identify a direction in which the virtual box is located relative to the vehicle 400. The processor may identify some of the representative points based on the direction in which the virtual box is located relative to a vehicle 400.

The processor may identify the virtual box 423 in the first boundary region 411 corresponding to a left boundary region of the LiDAR. The processor may identify that the virtual box 423 is located in the first boundary region 411 of the LiDAR, based on the virtual box 421 that was identified before the time the virtual box 423 had been identified.

The processor may identify the virtual box 433 in the second boundary region 413 corresponding to a right boundary region of the LiDAR. The processor may identify that the virtual box 433 is located in the second boundary region 413 of the LiDAR, based on the virtual box 431 that was identified before the time the virtual box 433 had been identified.

The processor may identify representative points of the virtual box 423, which are identified in a left direction of the vehicle 400 and which are located in the first boundary region 411 of the LiDAR. For example, the processor may identify representative points of the virtual box 423 based on identifying the virtual box 423, which is identified in the left direction of the vehicle 400 and which is located within a designated distance from the first boundary region 411 of the LiDAR. For example, the representative points of the virtual box 423 identified in the first boundary region 411 of the LiDAR may include some of the representative points identified in FIG. 3.

For example, the processor may identify a representative point indicating an upper side of the virtual box 423, a representative point indicating an upper center of the virtual box 423, a representative point indicating a maximum value of the first axis among a plurality of points included in the virtual box 423, a representative point indicating a minimum value of the second axis among the plurality of points included in the virtual box 423, and a representative point indicating a right side of the virtual box 423.

The processor may identify representative points of the virtual box 433, which are identified in a right direction of the vehicle 400 and which are located in the second boundary region 413 of the LiDAR. For example, the processor may identify representative points of the virtual box 433 based on identifying the virtual box 433, which is identified in the right direction of the vehicle 400 and which is located within a designated distance from the second boundary region 413 of the LiDAR. For example, the representative points of the virtual box 433 identified in the second boundary region 413 of the LiDAR may include some of the representative points identified in FIG. 3.

For example, the processor may identify a representative point indicating an upper side of the virtual box 433, a representative point indicating an upper center of the virtual box 433, a representative point indicating a maximum value of the first axis among a plurality of points included in the virtual box 433, a representative point indicating a maximum value of the second axis direction among the plurality of points included in the virtual box 433, and a representative point indicating a left side of the virtual box 433.

If the virtual box is identified in the boundary regions 411 and 413 of the LiDAR, the processor may obtain at least one of a predicted displacement, or a second displacement, or any combination thereof by using some of the representative points.

As described above, if a virtual box is identified in the boundary region of the LiDAR, the processor of the vehicle control apparatus may obtain at least one of the second displacement, or the predicted displacement, or any combination thereof by using some of the representative points to increase the reliability of a displacement.

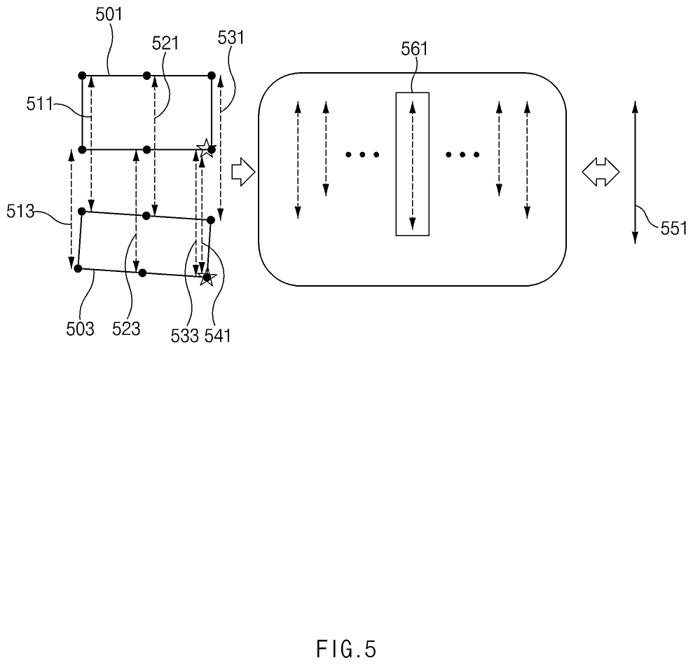

FIG. 5 shows an example of obtaining a displacement based on first representative points of a virtual box identified at a first time point and second representative points of a virtual box identified at a second time point.

Referring to FIG. 5, a processor (e.g., the processor 110 in FIG. 1) of a vehicle control apparatus (e.g., the vehicle control apparatus 100 of FIG. 1may identify a predicted displacement 551. For example, the processor may identify a first speed of an external vehicle at a first time point. The processor may apply the first speed to a first virtual box identified at the first time point. The processor may obtain the predicted displacement 551 based on applying the first speed to the first virtual box identified at the first time point.

The processor may identify a first virtual box 501 based on a plurality of points identified at the first time point. The processor may identify a second virtual box 503 based on a plurality of points identified at the second time point.

For example, the processor may identify first representative points included in the first virtual box 501. For example, the first representative points included in the first virtual box 501 may include at least one of the representative points described in FIG. 3.

For example, the processor may identify second representative points included in the second virtual box 503. For example, the second representative points included in the second virtual box 503 may include at least one of the representative points described in FIG. 3.

The processor may obtain displacements 511, 513, 521, 523, 531, 533, and 541 based on the first representative points included in the first virtual box 501 and the second representative points included in the second virtual box 503. For example, the processor may identify the displacements 511, 513, 521, 523, 531, 533, and 541 based on a difference between the first representative points included in the first virtual box 501 and the second representative points, which correspond to the first representative points and which are included in the second virtual box 503.

The processor may select a second displacement 561, which has the smallest difference from the predicted displacement 551, from among the displacements 511, 513, 521, 523, 531, 533, and 541.

In an embodiment, the processor may obtain one of a second speed, a third speed, or a fourth speed by using the selected second displacement 561.

For example, the processor may obtain the second speed based on dividing the second displacement 561 by a time difference between the first time point, at which the first virtual box 501 has been obtained, and the second time point at which the second virtual box 503 has been obtained.

For example, the processor may obtain a third displacement based on applying the algorithm to the first points included in the first virtual box 501 and the second points included in the second virtual box 503. The processor may obtain an average of the third displacement and the second displacement 561. The processor may obtain the third speed based on dividing the average of the third displacement and the second displacement 561 by the time difference between the first time point, at which the first virtual box 501 has been obtained, and the second time point at which the second virtual box 503 has been obtained.

For example, the processor may obtain a fourth displacement based on the second displacement 561 and the predicted displacement 551. The processor may apply a weight to each of the second displacement 561 and the predicted displacement 551 based on a difference between the second displacement 561 and the predicted displacement 551 being greater than or equal to a threshold value. For example, the processor may apply a first weight to the second displacement 561, and may apply a second weight to the predicted displacement 551. The processor may obtain the fourth displacement obtained by dividing the sum of the second displacement 561, to which the first weight is applied, and the predicted displacement 551, to which the second weight is applied, by 2. The processor may obtain the fourth speed based on dividing the fourth displacement obtained by dividing the sum of the second displacement 561 to which the first weight is applied and the predicted displacement 551, to which the second weight is applied, by 2 by the time difference between the first time point at which the first virtual box 501 has been obtained and the second time point at which the second virtual box 503 has been obtained.

The processor may assign one of the second speed, the third speed, or the fourth speed, which are obtained, to the second virtual box 503.

As described above, the processor of the vehicle control apparatus may stabilize the speed of the second virtual box 503 by assigning one of the second speed, the third speed, or the fourth speed to the second virtual box 503. The processor may reduce an error in the vehicle control system associated with the vehicle control apparatus by assigning one of the second speed, the third speed, or the fourth speed to the second virtual box 503. For example, the vehicle control system may include a control system that assists the driving of the vehicle.

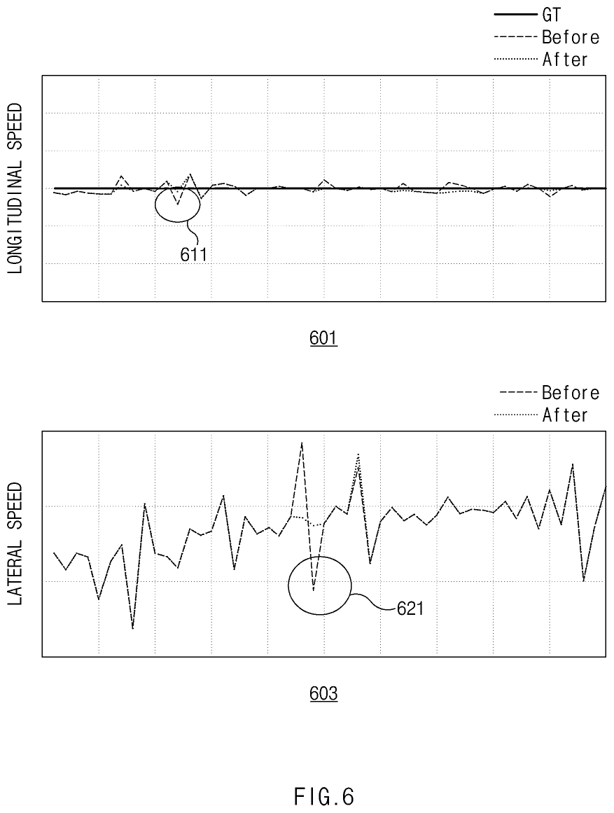

FIG. 6 shows an example of a result, to which one or more aspects of the present disclosure is applied, and an example of a result to which the one or more aspects of the present disclosure is not applied.

A first example 601 in FIG. 6 may include an example expressing a longitudinal speed of a vehicle. A second example 603 in FIG. 6 may include an example expressing a lateral speed of the vehicle.

When the present technology is not applied, outliers 611 and 621 may be identified in a first graph shown in the first example 601 and a second graph shown in the second example 603, respectively. Cases where the outliers 611 and 621 are identified may include cases where the speed of an external vehicle changes suddenly. When the speed of the external vehicle changes suddenly, an error may occur while the vehicle control system related to the vehicle control apparatus performs driving assistance of the vehicle.

Accordingly, the vehicle control apparatus (e.g., the vehicle control apparatus 100 of FIG. 1) may reduce the occurrence of the outliers 611 and 621 by applying the present technology. For example, the vehicle control apparatus may stably output at least one of a longitudinal speed of the external vehicle, or a lateral speed of the external vehicle, or any combination thereof by performing different operations depending on the speed of the external vehicle.

The vehicle control apparatus may reduce a root mean squared error (RMSE) by applying the present technology. The vehicle control apparatus may obtain ground truth (GT) depending on driving situations and may reduce errors in the speed of external objects by applying the present technology.

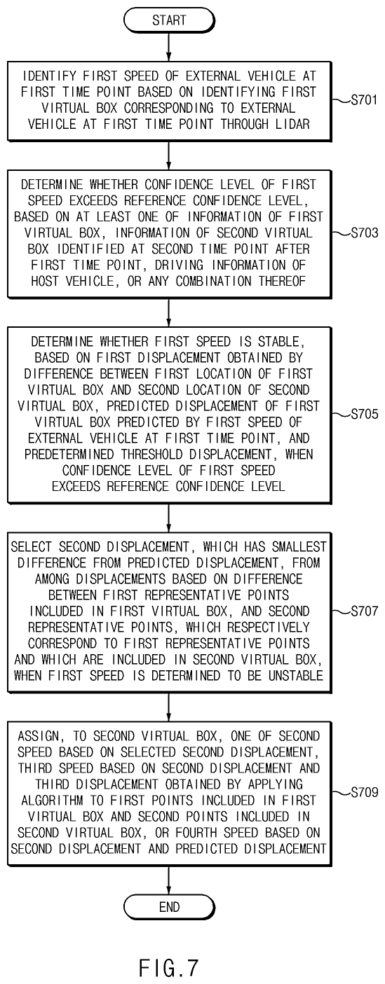

Hereinafter, a vehicle controlling method according to the present disclosure will be described in detail with reference to FIG. 7. FIG. 7 shows an example of a flowchart related to a vehicle control method.

Hereinafter, it is assumed that the vehicle control apparatus 100 of FIG. 1 performs the process of FIG. 7. In addition, in a description of FIG. 7, it may be understood that an operation described as being performed by a processor is controlled by the processor 110 of the vehicle control apparatus 100.

At least one of operations of FIG. 7 may be performed by the vehicle control apparatus 100 of FIG. 1. Each of the operations in FIG. 7 may be performed sequentially, but is not necessarily sequentially performed. For example, the order of operations may be changed, and at least two operations may be performed in parallel.

Referring to FIG. 7, in operation S701, a vehicle control method may include an operation of identifying a first speed of an external vehicle at the first time point based on identifying a first virtual box corresponding to the external vehicle at the first time point through a LiDAR (e.g., the LiDAR 120 in FIG. 1).

In operation S703, the vehicle control method may include an operation of determining whether a confidence level of the first speed exceeds a reference confidence level, based on at least one of information of the first virtual box, information of a second virtual box identified at a second time point after the first time point, or driving information of a vehicle, or any combination thereof.

The vehicle control method may include an operation of identifying the confidence level of the first speed based on at least one of a difference between a first size of the first virtual box and a second size of the second virtual box, a difference between a first heading direction of the first virtual box and a second heading direction of the second virtual box, a difference between a first yaw rate of the vehicle identified at the first time point and a second yaw rate of the vehicle identified at the second time point, a difference between a first width of the first virtual box and a second width of the second virtual box, whether the first location and the second location are located in a boundary region of the LiDAR, or whether the first virtual box or the second virtual box is occluded, or any combination thereof.

For example, the boundary region of the LiDAR may include a region within a designated distance from a boundary line of a field of view (FOV) of the LiDAR.

The vehicle control method may include an operation of increasing the confidence level of the first speed based on a fact that the difference between the first size of the first virtual box and the second size of the second virtual box is smaller than or equal to a reference rate, the difference between the first heading direction of the first virtual box and the second heading direction of the second virtual box is smaller than or equal to a reference angle, the difference between the first width of the first virtual box and the second width of the second virtual box is smaller than or equal to a reference width, the first virtual box and the second virtual box are not located in the boundary region of the LiDAR, a component of a first axis direction included in the first heading direction of first virtual box and the second heading direction of the second virtual box is greater than a component of a second axis direction, the first virtual box and the second virtual box are not occluded, or the difference between the first yaw rate of the vehicle identified at the first time point and the second yaw rate of the vehicle identified at the second time point is smaller than or equal to a reference yaw rate.

The vehicle control method may include an operation of initializing the confidence level of the first speed based on a fact that the difference between the first size of the first virtual box and the second size of the second virtual box exceeds a reference rate, the difference between the first heading direction of the first virtual box and the second heading direction of the second virtual box exceeds a reference angle, the difference between the first width of the first virtual box and the second width of the second virtual box exceeds a reference width, the difference between a speed of the vehicle at the first time point and the speed of the vehicle at the second time point exceeds a reference speed, or the difference between the first yaw rate of the vehicle identified at the first time point and the second yaw rate of the vehicle identified at the second time point exceeds a reference yaw rate.

In operation S705, the vehicle control method may include an operation of determining whether the first speed is stable, based on a first displacement obtained by a difference between a first location of the first virtual box and a second location of the second virtual box, a predicted displacement of the first virtual box predicted by the first speed of the external vehicle at the first time point, and a predetermined threshold displacement, when the confidence level of the first speed exceeds the reference confidence level.

The vehicle control method may include an operation of determining that the first speed is unstable, based on a difference between the first displacement and the predicted displacement exceeding the threshold displacement. The vehicle control method may include an operation of determining that the first speed is stable, based on the difference between the first displacement and the predicted displacement being smaller than or equal to the threshold displacement.

The vehicle control method may include an operation of assigning the first speed to the second virtual box when the confidence level of the first speed is smaller than or equal to a first reference confidence level.

The vehicle control method may include an operation of determining that the first speed is unstable, based on the difference between the first displacement and the predicted displacement exceeding a first threshold displacement, when the confidence level of the first speed exceeds the first reference confidence level and is smaller than or equal to a second reference confidence level exceeding the first reference confidence level.

The vehicle control method may include an operation of determining that the first speed is unstable, based on the difference between the first displacement and the predicted displacement exceeding a second threshold displacement smaller than the first threshold displacement, when the confidence level of the first speed exceeds the second reference confidence level.

The vehicle control method may include an operation of determining that the first speed is unstable, based on the difference between the first displacement and the predicted displacement exceeding a third threshold displacement exceeding the first threshold displacement when the first virtual box or the second virtual box is identified in a boundary region of the LiDAR.

In operation S707, the vehicle control method may include an operation of selecting a second displacement, which has the smallest difference from the predicted displacement, from among displacements based on a difference between first representative points included in the first virtual box, and second representative points, which respectively correspond to the first representative points and which are included in the second virtual box, when the first speed is determined to be unstable.

The vehicle control method may include an operation of identifying, as at least one of the first representative points and the second representative points, at least one of a minimum value of a first axis, a maximum value of the first axis, a minimum value of a second axis, or a maximum value of the second axis, or any combination thereof from vertices of the first virtual box and the second virtual box, and points included in the first virtual box and the second virtual box on a plane, which is formed by the first axis and the second axis among the first axis, the second axis, and a third axis.

The vehicle control method may include an operation of obtaining some of the first representative points or some of the second representative points based on a direction, in which the first virtual box is located relative to the vehicle, when the first virtual box or the second virtual box is identified in a boundary region of the LiDAR.

In operation S709, the vehicle control method may include an operation of assigning, to the second virtual box, one of a second speed based on the selected second displacement, a third speed based on the second displacement and a third displacement obtained by applying an algorithm to first points included in the first virtual box and second points included in the second virtual box, or a fourth speed based on the second displacement and the predicted displacement.

The vehicle control method may include an operation of assigning the second speed to the second virtual box when the first virtual box and the second virtual box are identified as exceeding a designated distance from the vehicle not to apply the algorithm to the first points and the second points.

The vehicle control method may include an operation of obtaining the third displacement based on applying the algorithm to the first points and the second points when the first virtual box and the second virtual box are identified at a designated distance or less from the vehicle to apply the algorithm to the first points and the second points. The vehicle control method may include an operation of assigning the third speed, which is based on the average of the third displacement and the second displacement, to the second virtual box.

The vehicle control method may include an operation of obtaining a fourth displacement by applying a weight to each of the second displacement and the predicted displacement based on a difference between the second displacement and the predicted displacement being greater than or equal to a threshold value. According to an embodiment, the vehicle control method may include an operation of assigning the fourth speed to the second virtual box based on obtaining the fourth speed by using the fourth displacement.

As described above, the vehicle control method according to an embodiment may perform various operations to stabilize the speed of the second virtual box identified at the second time point when the first speed of the external vehicle identified at the first time point is not stable. According to an embodiment, the vehicle control method may assign, to the second virtual box, one of a second speed based on the selected second displacement, a third speed based on the second displacement and the third displacement, which is obtained by applying the algorithm to the first points included in the first virtual box and the second points included in the second virtual box, or a fourth speed based on the second displacement and the predicted displacement, thereby stabilizing a speed of the second virtual box identified at the second time point.

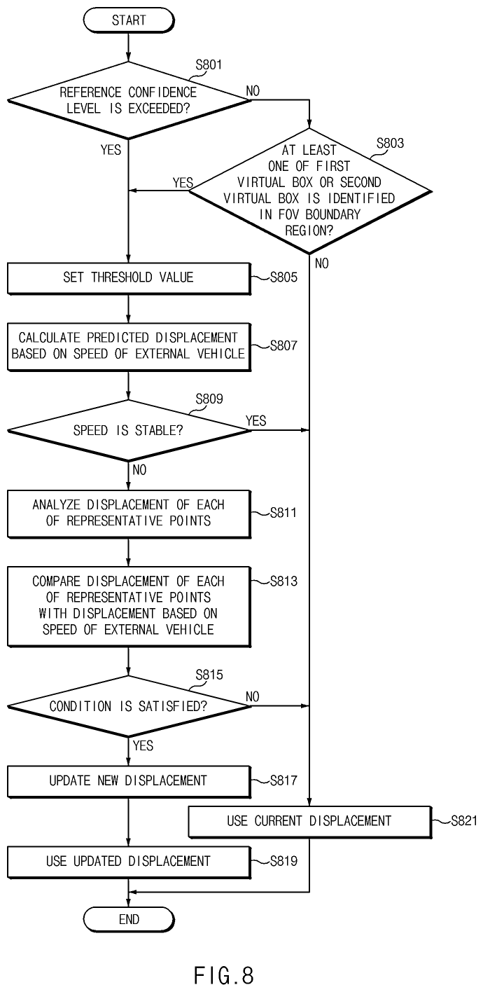

Hereinafter, a vehicle controlling method according to an embodiment of the present disclosure will be described in detail with reference to FIG. 8. FIG. 8 shows an example of a flowchart related to a vehicle control method.

Hereinafter, it is assumed that the vehicle control apparatus 100 of FIG. 1 performs the process of FIG. 8. In addition, in a description of FIG. 8, it may be understood that an operation described as being performed by a processor is controlled by the processor 110 of the vehicle control apparatus 100.

At least one of operations of FIG. 8 may be performed by the vehicle control apparatus 100 of FIG. 1. Each of the operations in FIG. 8 may be performed sequentially, but is not necessarily sequentially performed. For example, the order of operations may be changed, and at least two operations may be performed in parallel.

Referring to FIG. 8, in operation S801, a vehicle control method may include an operation of determining whether a first speed of an external vehicle identified at a first time point exceeds a reference confidence level.

When the first speed of the external vehicle identified at the first time point does not exceed the reference confidence level (No in operation S801), in operation S803, the vehicle control method may include an operation of determining whether at least one of a first virtual box corresponding to the external vehicle identified at the first time point or a second virtual box corresponding to the external vehicle identified at a second time point after the first time point is identified in a boundary region of a field of view (FOV) of a LiDAR.

When the first speed of the external vehicle identified at the first time point exceeds the reference confidence level (Yes in operation S801), or at least one of the first virtual box or the second virtual box is identified in the FOV boundary region (Yes in operation S803), in operation S805, the vehicle control method may include an operation of setting a threshold value depending on a confidence level of the first speed. For example, the threshold value may include the threshold displacement described in FIG. 1.

In operation S807, the vehicle control method may include an operation of calculating a predicted displacement based on the speed of the external vehicle. For example, the vehicle control method may include an operation of calculating a predicted displacement corresponding to changes in the first virtual box and second virtual box location by using the first speed of the external vehicle.

For example, the vehicle control method may include an operation of estimating a location of the second virtual box by applying the first speed of the external vehicle to the first virtual box and calculating the predicted displacement based on a difference between the estimated location of the second virtual box and the location of the first virtual box.

In operation S809, the vehicle control method may include an operation of determining whether the speed of the external vehicle is stable. For example, the vehicle control method may include an operation of determining whether the first speed of the external vehicle is stable. For example, the vehicle control method may include an operation of determining whether the first speed is stable, based on a difference between the predicted displacement obtained in operation S807 and an observed displacement obtained based on the difference between the observed location of the first virtual box and the observed location of the second virtual box.

If the speed of the external vehicle is unstable (No in operation S809), in operation S811, the vehicle control method may include an operation of analyzing the displacement of each of representative points.

For example, the vehicle control method may include an operation of identifying first representative points of the first virtual box obtained at the first time point. For example, may include an operation of the vehicle control method identifying second representative points of the second virtual box obtained at the second time point. The vehicle control method may include an operation of identifying the second representative points respectively corresponding to the first representative points and respectively comparing locations of the first representative points and locations of the second representative points corresponding to the first representative points. The vehicle control method may include an operation of obtaining displacements of the first representative points and the second representative points respectively corresponding to the first representative points based on comparing the locations of the first representative points with the locations of the second representative points respectively corresponding to the first representative points.

In operation S813, the vehicle control method may include an operation of comparing a displacement of each of representative points with a displacement based on the speed of the external vehicle. For example, the displacement based on the speed of an external vehicle may include a predicted displacement.

In operation S815, the vehicle control method may include an operation of determining whether a displacement of each of the representative points satisfies a condition, based on comparing the displacement of each of the representative points with the predicted displacement.

For example, the vehicle control method may include an operation of comparing the displacement of each of the representative points with the predicted displacement. The vehicle control method may include an operation of obtaining a displacement having the smallest difference from the predicted displacement based on comparing the displacement of each of the representative points with the predicted displacement.

If the condition is satisfied (Yes in operation S815), in operation S817, the vehicle control method may include an operation of updating a new displacement.

For example, the vehicle control method may include an operation of updating the displacement having the smallest difference from the predicted displacement so as to be changed to a new displacement.

For example, the vehicle control method may include an operation of updating the displacement obtained by using the ICP algorithm so as to be changed to the new displacement when the displacement obtained by using an ICP algorithm has the smallest difference from the predicted displacement.

For example, the vehicle control method may include an operation of identifying that the displacement updated to be changed to the new displacement is unstable, when a difference between the displacement updated to be changed to the new displacement and the predicted displacement is greater than or equal to a threshold value.

The vehicle control method may include an operation of applying a designated operation (e.g., weight sum operation) to the predicted displacement and the displacement updated to be changed to the new displacement, when the displacement updated to be changed to the new displacement is unstable.

In operation S819, the vehicle control method may include an operation of using the updated displacement. For example, the vehicle control method may include an operation of calculating a speed to be assigned to the second virtual box by using the updated displacement. For example, the vehicle control method may include an operation of assigning the calculated speed to the second virtual box based on calculating the speed to be assigned to the second virtual box by using the updated displacement.

If the first virtual box or the second virtual box is not identified in a FOV region (No in operation S803), the speed of the external vehicle is stable (Yes in operation S809), or the condition is not satisfied (No in operation S815), in operation S821, the vehicle control method may include an operation of using a current displacement.

For example, the vehicle control method may include an operation of obtaining the current displacement based on the observed location of the first virtual box and the observed location of the second virtual box. For example, the vehicle control method may include an operation of calculating a speed to be assigned to the second virtual box based on obtaining the current displacement.

According to an aspect of the present disclosure, a vehicle control apparatus may include a light detection and ranging (LiDAR) and a processor. The processor may identify a first speed of an external vehicle at a first time point based on identifying a first virtual box corresponding to the external vehicle at the first time point, through the LiDAR, may determine whether a confidence level of the first speed exceeds a reference confidence level, based on at least one of information of the first virtual box, information of a second virtual box identified at a second time point after the first time point, or driving information of a vehicle, or any combination thereof, may determine whether the first speed is stable, based on a first displacement obtained by a difference between a first location of the first virtual box and a second location of the second virtual box, a predicted displacement of the first virtual box predicted by the first speed of the external vehicle at the first time point, and a predetermined threshold displacement, when the confidence level of the first speed exceeds the reference confidence level, may select a second displacement, which has the smallest difference from the predicted displacement, from among displacements based on a difference between first representative points included in the first virtual box, and second representative points, which respectively correspond to the first representative points and which are included in the second virtual box, when the first speed is determined to be unstable, and may assign, to the second virtual box, one of a second speed based on the selected second displacement, a third speed based on the second displacement and a third displacement obtained by applying an algorithm to first points included in the first virtual box and second points included in the second virtual box, or a fourth speed based on the second displacement and the predicted displacement.

In an example, the processor may identify the confidence level of the first speed based on at least one of a difference between a first size of the first virtual box and a second size of the second virtual box, a difference between a first heading direction of the first virtual box and a second heading direction of the second virtual box, a difference between a first yaw rate of the vehicle identified at the first time point and a second yaw rate of the vehicle identified at the second time point, a difference between a first width of the first virtual box and a second width of the second virtual box, whether the first location and the second location are located in a boundary region of the LiDAR, or whether the first virtual box or the second virtual box is occluded, or any combination, and wherein the boundary region of the LiDAR includes a region within a designated distance from a boundary line of a field of view (FOV) of the LiDAR. The boundary region of the LiDAR may include a region within a designated distance from a boundary line of a field of view (FOV) of the LiDAR.

In an example, the processor may increase the confidence level of the first speed based on a fact that the difference between the first size of the first virtual box and the second size of the second virtual box is smaller than or equal to a reference rate, he difference between the first heading direction of the first virtual box and the second heading direction of the second virtual box is smaller than or equal to a reference angle, the difference between the first width of the first virtual box and the second width of the second virtual box is smaller than or equal to a reference width, the first virtual box and the second virtual box are not located in the boundary region of the LiDAR, a component of a first axis direction included in the first heading direction of first virtual box and the second heading direction of the second virtual box is greater than a component of a second axis direction, the first virtual box and the second virtual box are not occluded, or the difference between the first yaw rate of the vehicle identified at the first time point and the second yaw rate of the vehicle identified at the second time point is smaller than or equal to a reference yaw rate.

In an example, the processor may initialize the confidence level of the first speed based on a fact that the difference between the first size of the first virtual box and the second size of the second virtual box exceeds a reference rate, the difference between the first heading direction of the first virtual box and the second heading direction of the second virtual box exceeds a reference angle, the difference between the first width of the first virtual box and the second width of the second virtual box exceeds a reference width, the difference between a speed of the vehicle at the first time point and the speed of the vehicle at the second time point exceeds a reference speed, or the difference between the first yaw rate of the vehicle identified at the first time point and the second yaw rate of the vehicle identified at the second time point exceeds a reference yaw rate.

In an example, the processor may determine that the first speed is unstable, based on a difference between the first displacement and the predicted displacement exceeding the threshold displacement, and may determine that the first speed is stable, based on the difference between the first displacement and the predicted displacement being smaller than or equal to the threshold displacement.

In an example, the processor may assign the first speed to the second virtual box when the confidence level of the first speed is smaller than or equal to a first reference confidence level, may determine that the first speed is unstable, based on the difference between the first displacement and the predicted displacement exceeding a first threshold displacement when the confidence level of the first speed exceeds the first reference confidence level and is smaller than or equal to a second reference confidence level exceeding the first reference confidence level, may determine that the first speed is unstable, based on the difference between the first displacement and the predicted displacement exceeding a second threshold displacement smaller than the first threshold displacement when the confidence level of the first speed exceeds the second reference confidence level, and may determine that the first speed is unstable, based on the difference between the first displacement and the predicted displacement exceeding a third threshold displacement exceeding the first threshold displacement when the first virtual box or the second virtual box is identified in a boundary region of the LiDAR. The boundary region of the LiDAR may include a region within a designated distance from a boundary line of a FOV of the LiDAR.

In an example, the processor may identify, as at least one of the first representative points and the second representative points, at least one of vertices of the first virtual box and the second virtual box, a minimum value of a first axis, a maximum value of the first axis, a minimum value of a second axis, or a maximum value of the second axis, or any combination thereof and points included in the first virtual box and the second virtual box on a plane, which is formed by the first axis and the second axis among the first axis, the second axis, and a third axis.

In an example, the processor may obtain some of the first representative of points or some the second representative points based on a direction, in which the first virtual box is located relative to the vehicle, when the first virtual box or the second virtual box is identified in a boundary region of the LiDAR. The boundary region of the LiDAR may include a region within a designated distance from a boundary line of a FOV of the LiDAR.

In an example, the processor may assign the second speed to the second virtual box when the first virtual box and the second virtual box are identified as exceeding a designated distance from the vehicle not to apply the algorithm to the first points and the second points.

In an example, the processor may obtain the third displacement based on applying the algorithm to the first points and the second points when the first virtual box and the second virtual box are identified at a designated distance or less from the vehicle to apply the algorithm to the first points and the second points, and may assign the third speed, which is based on an average of the third displacement and the second displacement, to the second virtual box.

In an example, the processor may obtain a fourth displacement by applying a weight to each of the second displacement and the predicted displacement based on a difference between the second displacement and the predicted displacement being greater than or equal to a threshold value and may assign the fourth speed to the second virtual box based on obtaining the fourth speed by using the fourth displacement.

According to an aspect of the present disclosure, a vehicle control method may include identifying a first speed of an external vehicle at a first time point based on identifying a first virtual box corresponding to the external vehicle at the first time point, through a LiDAR, determining whether a confidence level of the first speed exceeds a reference confidence level, based on at least one of information of the first virtual box, information of a second virtual box identified at a second time point after the first time point, driving information of a vehicle, or any combination thereof, determining whether the first speed is stable, based on a first displacement obtained by a difference between a first location of the first virtual box and a second location of the second virtual box, a predicted displacement of the first virtual box predicted by the first speed of the external vehicle at the first time point, and a predetermined threshold displacement, when the confidence level of the first speed exceeds the reference confidence level, selecting a second displacement, smallest which has the difference from the predicted displacement, from among displacements based on a difference between first representative points included in the first virtual box, and second representative points, which respectively correspond to the first representative points and which are included in the second virtual box, when the first speed is determined to be unstable, and assigning, to the second virtual box, one of a second speed based on the selected second displacement, a third speed based on the second displacement and a third displacement obtained by applying an algorithm to first points included in the first virtual box and second points included in the second virtual box, or a fourth speed based on the second displacement and the predicted displacement.

According to an example, the vehicle control method may further include identifying the confidence level of the first speed based on at least one of a difference between a first size of the first virtual box and a second size of the second virtual box, a difference between a first heading direction of the first virtual box and a second heading direction of the second virtual box, a difference between a first yaw rate of the vehicle identified at the first time point and a second yaw rate of the vehicle identified at the second time point, a difference between a first width of the first virtual box and a second width of the second virtual box, whether the first location and the second location are located in a boundary region of the LiDAR, or whether the first virtual box or the second virtual box is occluded, or any combination thereof. The boundary region of the LiDAR may include a region within a designated distance from a boundary line of a field of view (FOV) of the LiDAR.

According to an example, the vehicle control method may further include increasing the confidence level of the first speed based on a fact that the difference between the first size of the first virtual box and the second size of the second virtual box is smaller than or equal to a reference rate, the difference between the first heading direction of the first virtual box and the second heading direction of the second virtual box is smaller than or equal to a reference angle, the difference between the first width of the first virtual box and the second width of the second virtual box is smaller than or equal to a reference width, the first virtual box and the second virtual box are not located in the boundary region of the LiDAR, a component of a first axis direction included in the first heading direction of first virtual box and the second heading direction of the second virtual box is greater than a component of a second axis direction, the first virtual box and the second virtual box are not occluded, or the difference between the first yaw rate of the vehicle identified at the first time point and the second yaw rate of the vehicle identified at the second time point is smaller than or equal to a reference yaw rate.

According to an example, the vehicle control method may further include initializing the confidence level of the first speed based on a fact that the difference between the first size of the first virtual box and the second size of the second virtual box exceeds a reference rate, the difference between the first heading direction of the first virtual box and the second heading direction of the second virtual box exceeds a reference angle, the difference between the first width of the first virtual box and the second width of the second virtual box exceeds a reference width, the difference between a speed of the vehicle at the first time point and the speed of the vehicle at the second time point exceeds a reference speed, or the difference between the first yaw rate of the vehicle identified at the first time point and the second yaw rate of the vehicle identified at the second time point exceeds a reference yaw rate.

According to an example, the vehicle control method may further include determining that the first speed is unstable, based on a difference between the first displacement and the predicted displacement exceeding the threshold displacement, and determining that the first speed is stable, based on the difference between the first displacement and the predicted displacement being smaller than or equal to the threshold displacement.

According to an example, the vehicle control method may further include assigning the first speed to the second virtual box when the confidence level of the first speed is smaller than or equal to a first reference confidence level, determining that the first speed is unstable, based on the difference between the first displacement and the predicted displacement exceeding a first threshold displacement when the confidence level of the first speed exceeds the first reference confidence level and is smaller than or equal to a second reference confidence level exceeding the first reference confidence level, determining that the first speed is unstable, based on the difference between the first displacement and the predicted displacement exceeding a second threshold displacement smaller than the first threshold displacement when the confidence level of the first speed exceeds the second reference confidence level, and determining that the first speed is unstable, based on the difference between the first displacement and the predicted displacement exceeding a third threshold displacement exceeding the first threshold displacement when the first virtual box or the second virtual box is identified in a boundary region of the LiDAR. The boundary region of the LiDAR may include a region within a designated distance from a boundary line of a FOV of the LiDAR.

According to an example, the vehicle control method may further include identifying, as at least one of the first representative points and the second representative points, at least one of vertices of the first virtual box and the second virtual box, a minimum value of a first axis, a maximum value of the first axis, a minimum value of a second axis, or a maximum value of the second axis, or any combination thereof, and points included in the first virtual box and the second virtual box on a plane, which is formed by the first axis and the second axis among the first axis, the second axis, and a third axis.

According to an example, the vehicle control method may further include obtaining some of the first representative points or some of the second representative points based on a direction, in which the first virtual box is located relative to the vehicle, when the first virtual box or the second virtual box is identified in a boundary region of the LiDAR. The boundary region of the LiDAR may include a region within a designated distance from a boundary line of a FOV of the LiDAR.

According to an example, the vehicle control method may further include assigning the second speed to the second virtual box when the first virtual box and the second virtual box are identified as exceeding a designated distance from the vehicle not to apply the algorithm to the first points and the second points, obtaining the third displacement based on applying the algorithm to the first points and the second points when the first virtual box and the second virtual box are identified at a designated distance or less from the vehicle to apply the algorithm to the first points and the second points, assigning the third speed, which is based on an average of the third displacement and the second displacement, to the second virtual box, obtaining a fourth displacement by applying a weight to each of the second displacement and the predicted displacement based on a difference between the second displacement and the predicted displacement being greater than or equal to a threshold value, and assigning the fourth speed to the second virtual box based on obtaining the fourth speed by using the fourth displacement.

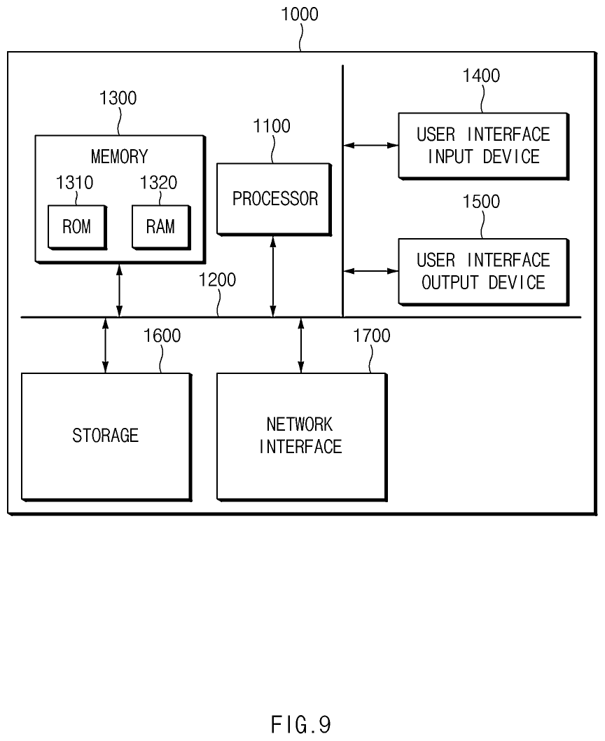

FIG. 9 illustrates an example of a computing system related to a vehicle control apparatus or vehicle control method.

Referring to FIG. 9, a computing system 1000 may include at least one processor 1100, a memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read only memory (ROM) and a random access memory (RAM).

Accordingly, the operations of the method or algorithm described in connection with the embodiment(s) disclosed in the specification may be directly implemented with a hardware module, or a software module, or any combination thereof, which is executed by the processor 1100. The software module may reside on a storage medium (i.e., the memory 1300 and/or the storage 1600) such as a random access memory (RAM), a flash memory, a read only memory (ROM), an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

The above description is merely an example of the technical idea of the present disclosure, and various modifications and modifications may be made by one skilled in the art without departing from the essential characteristic of the present disclosure.

Accordingly, various examples of the present disclosure are intended not to limit but to explain the technical idea of the present disclosure, and the scope and spirit of the present disclosure is not limited by the above examples. The scope of protection of the present disclosure should be construed by the attached claims, and all equivalents thereof should be construed as being included within the scope of the present disclosure.

The present technology may identify a speed to be assigned to a virtual box by using at least one of a speed of an external vehicle, or a displacement of the virtual box corresponding to the external vehicle, or any combination thereof.

Moreover, the present technology may determine a virtual box having an unstable speed and may assign a stable speed to the virtual box having the unstable speed.

Furthermore, the present technology may reduce a speed error a caused by a shape error of an object.

Besides, a variety of effects directly or indirectly understood through the specification may be provided.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. An apparatus s of a first vehicle, the apparatus comprising:
at least one sensor; and
a processor,
wherein the processor is configured to:
determine, based on the at least one sensor, a first virtual box corresponding to an external vehicle and associated with a first time point;
identify, based on the first virtual box, a first speed of the external vehicle at the first time point;
determine whether a confidence level of the first speed exceeds a reference confidence level, based on at least one of information of the first virtual box, information of a second virtual box identified at a second time point after the first time point, or driving information of the first vehicle, or any combination thereof;
determine whether the first speed is stable, based on a first displacement obtained by a difference between a first location of the first virtual box and a second location of the second virtual box, a predicted displacement of the first virtual box predicted by the first speed of the external vehicle at the first time point, and a predetermined threshold displacement, after the confidence level of the first speed exceeds the reference confidence level;
select a second displacement, which has the smallest difference from the predicted displacement, from among displacements based on a difference between first representative points included in the first virtual box, and second representative points, which respectively correspond to the first representative points and which are included in the second virtual box, after the first speed is determined to be unstable; and
assign, to the second virtual box, one of a second speed based on the selected second displacement, a third speed based on the second displacement and a third displacement obtained by applying an algorithm to first points included in the first virtual box and second points included in the second virtual box, or a fourth speed based on the second displacement and the predicted displacement.

2. The apparatus of claim 1, wherein the processor is configured to:
identify the confidence level of the first speed based on at least one of a difference between a first size of the first virtual box and a second size of the second virtual box, a difference between a first heading direction of the first virtual box and a second heading direction of the second virtual box, a difference between a first yaw rate of the first vehicle identified at the first time point and a second yaw rate of the first vehicle identified at the second time point, a difference between a first width of the first virtual box and a second width of the second virtual box, whether the first location and the second location are located in a boundary region of the at least one sensor, or whether the first virtual box or the second virtual box is obstructed, or any combination thereof, and
wherein the boundary region of the at least one sensor comprises a region within a designated distance from a boundary line of a field of view (FOV) of the at least one sensor.

3. The apparatus of claim 2, wherein the processor is configured to:
increase the confidence level of the first speed based on the difference between the first size of the first virtual box and the second size of the second virtual box being smaller than or equal to a reference rate, the difference between the first heading direction of the first virtual box and the second heading direction of the second virtual box being smaller than or equal to a reference angle, the difference between the first width of the first virtual box and the second width of the second virtual box being smaller than or equal to a reference width, the first virtual box and the second virtual box being not located in the boundary region of the at least one sensor, a component of a first axis direction included in the first heading direction of first virtual box and the second heading direction of the second virtual box being greater than a component of a second axis direction, the first virtual box and the second virtual box being not obstructed, or the difference between the first yaw rate of the first vehicle identified at the first time point and the second yaw rate of the first vehicle identified at the second time point being smaller than or equal to a reference yaw rate.

4. The apparatus of claim 2, wherein the processor is configured to:
initialize the confidence level of the first speed based on the difference between the first size of the first virtual box and the second size of the second virtual box exceeding a reference rate, the difference between the first heading direction of the first virtual box and the second heading direction of the second virtual box exceeding a reference angle, the difference between the first width of the first virtual box and the second width of the second virtual box exceeding a reference width, the difference between a speed of the first vehicle at the first time point and the speed of the first vehicle at the second time point exceeding a reference speed, or the difference between the first yaw rate of the first vehicle identified at the first time point and the second yaw rate of the first vehicle identified at the second time point exceeding a reference yaw rate.

5. The apparatus of claim 1, wherein the processor is configured to:
determine that the first speed is unstable, based on a difference between the first displacement and the predicted displacement exceeding the threshold displacement; and
determine that the first speed is stable, based on the difference between the first displacement and the predicted displacement being smaller than or equal to the threshold displacement.

6. The apparatus of claim 5, wherein the processor is configured to:
assign the first speed to the second virtual box based on the confidence level of the first speed being smaller than or equal to a first reference confidence level;
determine that the first speed is unstable, based on the difference between the first displacement and the predicted displacement exceeding a first threshold displacement when the confidence level of the first speed exceeds the first reference confidence level and is smaller than or equal to a second reference confidence level exceeding the first reference confidence level;
determine that the first speed is unstable, based on the difference between the first displacement and the predicted displacement exceeding a second threshold displacement smaller than the first threshold displacement when the confidence level of the first speed exceeds the second reference confidence level; and
determine that the first speed is unstable, based on the difference between the first displacement and the predicted displacement exceeding a third threshold displacement exceeding the first threshold displacement when the first virtual box or the second virtual box is identified in a boundary region of the at least one sensor, and
wherein the boundary region of the at least one sensor comprises a region within a designated distance from a boundary line of a field of view (FOV) of the at least one sensor.

7. The apparatus of claim 1, wherein the processor is configured to:
identify, as at least one of the first representative points and the second representative points, at least one of vertices of the first virtual box and the second virtual box, a minimum value of a first axis, a maximum value of the first axis, a minimum value of a second axis, or a maximum value of the second axis, or any combination thereof and points included in the first virtual box and the second virtual box on a plane, which is formed by the first axis and the second axis among the first axis, the second axis, and a third axis.

8. The apparatus of claim 1, wherein the processor is configured to:
obtain at least one of the first representative points or at least of the second representative points based on a direction, in which the first virtual box is located relative to the first vehicle, based on the first virtual box or the second virtual box being identified in a boundary region of the at least one sensor, and
wherein the boundary region of the at least one sensor comprises a region within a designated distance from a boundary line of a field of view (FOV) of the at least one sensor.

9. The apparatus of claim 1, wherein the processor is configured to:
assign the second speed to the second virtual box, based on the first virtual box and the second virtual box being identified as exceeding a designated distance from the first vehicle not to apply the algorithm to the first points and the second points.

10. The apparatus of claim 9, wherein the processor is configured to:
obtain the third displacement based on applying the algorithm to the first points and the second points, based on the first virtual box and the second virtual box being identified at a designated distance or less from the first vehicle to apply the algorithm to the first points and the second points; and
assign the third speed, which is based on an average of the third displacement and the second displacement, to the second virtual box.

11. The apparatus of claim 1, wherein the processor is configured to:
obtain a fourth displacement by applying a weight to each of the second displacement and the predicted displacement based on a difference between the second displacement and the predicted displacement being greater than or equal to a threshold value; and
assign the fourth speed to the second virtual box based on obtaining the fourth speed by using the fourth displacement.

12. A method performed by an apparatus of a first vehicle, the method comprising:
determining, based on at least one sensor, a first virtual box corresponding to an external vehicle and associated with a first time point;
identifying, based on the first virtual box, a first speed of the external vehicle at the first time point;
determining whether a confidence level of the first speed exceeds a reference confidence level, based on at least one of information of the first virtual box, information of a second virtual box identified at a second time point after the first time point, or driving information of the first vehicle, or any combination thereof;
determining whether the first speed is stable, based on a first displacement obtained by a difference between a first location of the first virtual box and a second location of the second virtual box, a predicted displacement of the first virtual box predicted by the first speed of the external vehicle at the first time point, and a predetermined threshold displacement, after the confidence level of the first speed exceeds the reference confidence level;
selecting a second displacement, which has the smallest difference from the predicted displacement, from among displacements based on a difference between first representative points included in the first virtual box, and second representative points, which respectively correspond to the first representative points and which are included in the second virtual box, after the first speed is determined to be unstable; and
assigning, to the second virtual box, one of a second speed based on the selected second displacement, a third speed based on the second displacement and a third displacement obtained by applying an algorithm to first points included in the first virtual box and second points included in the second virtual box, or a fourth speed based on the second displacement and the predicted displacement.

13. The method of claim 12, further comprising:
identifying the confidence level of the first speed based on at least one of a difference between a first size of the first virtual box and a second size of the second virtual box, a difference between a first heading direction of the first virtual box and a second heading direction of the second virtual box, a difference between a first yaw rate of the first vehicle identified at the first time point and a second yaw rate of the first vehicle identified at the second time point, a difference between a first width of the first virtual box and a second width of the second virtual box, whether the first location and the second location are located in a boundary region of the at least one sensor, or whether the first virtual box or the second virtual box is obstructed, or any combination thereof and
wherein the boundary region of the at least one sensor comprises a region within a designated distance from a boundary line of a field of view (FOV) of the at least one sensor.

14. The method of claim 13, further comprising:
increasing the confidence level of the first speed based on the difference between the first size of the first virtual box and the second size of the second virtual box being smaller than or equal to a reference rate, the difference between the first heading direction of the first virtual box and the second heading direction of the second virtual box being smaller than or equal to a reference angle, the difference between the first width of the first virtual box and the second width of the second virtual box being smaller than or equal to a reference width, the first virtual box and the second virtual box being not located in the boundary region of the at least one sensor, a component of a first axis direction included in the first heading direction of first virtual box and the second heading direction of the second virtual box being greater than a component of a second axis direction, the first virtual box and the second virtual box being not obstructed, or the difference between the first yaw rate of the first vehicle identified at the first time point and the second yaw rate of the first vehicle identified at the second time point being smaller than or equal to a reference yaw rate.

15. The method of claim 13, further comprising:
initializing the confidence level of the first speed based on the difference between the first size of the first virtual box and the second size of the second virtual box exceeding a reference rate, the difference between the first heading direction of the first virtual box and the second heading direction of the second virtual box exceeding a reference angle, the difference between the first width of the first virtual box and the second width of the second virtual box exceeding a reference width, the difference between a speed of the first vehicle at the first time point and the speed of the first vehicle at the second time point exceeding a reference speed, or the difference between the first yaw rate of the first vehicle identified at the first time point and the second yaw rate of the first vehicle identified at the second time point exceeding a reference yaw rate.

16. The method of claim 12, further comprising:
determining that the first speed is unstable, based on a difference between the first displacement and the predicted displacement exceeding the threshold displacement.

17. The method of claim 16, further comprising:
assigning the first speed to the second virtual box based on the confidence level of the first speed being smaller than or equal to a first reference confidence level;
determining that the first speed is unstable, based on the difference between the first displacement and the predicted displacement exceeding a first threshold displacement when the confidence level of the first speed exceeds the first reference confidence level and is smaller than or equal to a second reference confidence level exceeding the first reference confidence level;
determining that the first speed is unstable, based on the difference between the first displacement and the predicted displacement exceeding a second threshold displacement smaller than the first threshold displacement when the confidence level of the first speed exceeds the second reference confidence level; and
determining that the first speed is unstable, based on the difference between the first displacement and the predicted displacement exceeding a third threshold displacement exceeding the first threshold displacement when the first virtual box or the second virtual box is identified in a boundary region of the at least one sensor, and
wherein the boundary region of the at least one sensor comprises a region within a designated distance from a boundary line of a field of view (FOV) of the at least one sensor.

18. The method of claim 12, further comprising:
identifying, as at least one of the first representative points and the second representative points, at least one of vertices of the first virtual box and the second virtual box, a minimum value of a first axis, a maximum value of the first axis, a minimum value of a second axis, or a maximum value of the second axis, or any combination thereof and points included in the first virtual box and the second virtual box on a plane, which is formed by the first axis and the second axis among the first axis, the second axis, and a third axis.

19. The method of claim 12, further comprising:
obtaining at least one of the first representative points or at least one of the second representative points based on a direction, in which the first virtual box is located relative to the first vehicle, based on the first virtual box or the second virtual box being identified in a boundary region of the at least one sensor, and
wherein the boundary region of the at least one sensor comprises a region within a designated distance from a boundary line of a field of view (FOV) of the at least one sensor.

20. The method of claim 12, further comprising:
assigning the second speed to the second virtual box, based on the first virtual box and the second virtual box being identified as exceeding a designated distance from the firs vehicle not to apply the algorithm to the first points and the second points.
